(19) United States
(12) Patent Application Publication
(10) Pub. No.: US 2012/0313447 A1
(43) Pub. Date: Dec. 13, 2012

(54) METHOD OF PERFORMING BIDIRECTIONAL COMMUNICATION BETWEEN TRANSMITTER AND RECEIVER IN WIRELESS POWER TRANSMISSION/RECEPTION SYSTEM, THE TRANSMITTER, AND THE RECEIVER

(75) Inventors: Se-Ho Park, Suwon-si (KR); Young-Min Lee, Yongin-si (KR); Kyung-Woo Lee, Seoul (KR); Sung-Bum Park, Suwon-si (KR); Kang-Ho Byun, Suwon-si (KR)

(73) Assignee: Samsung Electronics Co., Ltd., Gyeonggi-do (KR)

(21) Appl. No.: 13/490,984

(22) Filed: Jun. 7, 2012

Related U.S. Application Data
(60) Provisional application No. 61/494,181, filed on Jun. 7, 2011.

(30) Foreign Application Priority Data
Jun. 5, 2012 (KR) 10-2012-0060569

(51) Int. Cl. H02J 17/00

(52) U.S. Cl. 307/104

(57) ABSTRACT

A method and apparatus for performing bidirectional communication between a transmitter and a receiver in a wireless power transmission system are provided. The method includes detecting the receiver; transmitting, when the receiver is detected, transmitting a predetermined level of power to the receiver through a transmission (Tx) resonator; receiving a request for transmitting wireless power from the receiver through a wireless communication module; allocating a Short IDentification (SID) and a time slot corresponding to the receiver; transmitting the SID and the time slot to the receiver through the wireless communication module; receiving a request for required power from the receiver through the wireless communication module; determining whether the required power is greater than a residual power of the transmitter; and when the required power is greater than the residual power, informing the receiver through the wireless communication module that the required power cannot be transmitted.

### PRIORITY

This application claims priority under 35 U.S.C. §119 to a U.S. Provisional Patent Application filed in the United States Patent and Trademark Office on Jun. 7, 2011 and assigned Ser. No. 61/494,181 and a Korean Patent Application filed in the Korean Intellectual Property Office on Jun. 5, 2012 and assigned Serial No. 10-2012-0060569, the entire contents of each of which are incorporated herein by reference.

### BACKGROUND OF THE INVENTION

1. Field of the Invention

The present invention relates generally to a wireless power transmission/reception system, and more particularly to a method and apparatuses for performing bidirectional communication between a transmitter and a receiver in a wireless power transmission/reception system, which can efficiently transmit/receive wireless power through bidirectional communication between the transmitter and the receiver.

2. Description of the Related Art

Technologies for performing wireless charging or contactless charging for various electronic devices have been recently developed. Wireless charging technology uses wireless power transmission/reception. For example, wireless charging technology may be implemented through a system in which a battery of a mobile phone can be automatically charged when the mobile phone is placed on a charging pad without connecting a separate charging connector to the mobile phone. Since such an electronic device can be wirelessly charged, the wireless charging technology can improve a water-proof function of the electronic device, and increase portability of the electronic device due to the removal of a need for a wired charger.

Wireless charging technology commonly includes an electromagnetic induction scheme using a coil, a resonance scheme using resonance, and/or a Radio Frequency (RF)/microwave Radiation scheme converting electrical energy to a microwave and transferring the converted microwave.

With respect to the resonance scheme among the above-listed schemes, Prof Soljacic of the Massachusetts Institute of Technology (MIT) announced a system in which electricity is wirelessly transferred using a power transmission principle of the resonance scheme based on a coupled mode theory that may be applied even when a device to be charged is separated from a charging device by several meters. This wireless charging system employs a concept in physics in which resonance is the tendency in which when a tuning fork, for example, oscillates at a particular frequency, a wine glass next to the tuning fork oscillates at the same frequency. Similarly, the research team resonated an electromagnetic wave containing electrical energy instead of resonating sounds. The resonated electrical energy is directly transferred only when there is a device having a resonance frequency and parts of electrical energy that are not used are reabsorbed into an electromagnetic field instead of being spread in the air. Therefore, the electrical energy does not affect surrounding machines or people, unlike other electromagnetic waves.

Charging using the resonance scheme is implemented as follows. A reception side (i.e., a reception-side device) that requires charging sends, to a transmission side (i.e., a transmission-side device) transmitting wireless power, a request for transmission of the wireless power. The transmission side supplies the wireless power to the reception side. Unlike the reception side, which performs communication such as requesting the transmission of the wireless power to the transmission side, the transmission side does not communicate with the reception side, except for transmitting the power in response to the request of the reception side. Therefore, in the resonance transmission scheme, problems where too much power may be supplied to the reception side, or power is not transmitted to the reception side may temporarily occur.

### SUMMARY OF THE INVENTION

Accordingly, an aspect of the present invention is to provide a method and apparatuses for performing bidirectional communication between the transmitter and the receiver in the wireless power transmission system, in order to efficiently transmit/receive wireless power through the bidirectional communication between the transmitter and the receiver in the wireless power transmission system.

In accordance with an aspect of the present invention, a method of performing bidirectional communication of a transmitter in a wireless power transmission/reception system is provided. The method includes, detecting a receiver; transmitting, when the receiver is detected, transmitting a predetermined level of power to the receiver through a transmission (Tx) resonator; receiving a request for transmitting wireless power from the receiver through a wireless communication module; allocating a Short IDentification (SID) and a time slot corresponding to the receiver; transmitting the SID and the time slot to the receiver through the wireless communication module; receiving a request for required power from the receiver through the wireless communication module; determining whether the required power is greater than a residual power of the transmitter; and when the required power is greater than the residual power, informing the receiver through the wireless communication module that the required power cannot be transmitted.

In accordance with another aspect of the present invention, a transmitter in a wireless power transmission/reception system is provided. The transmitter includes a transmission (Tx) resonator for transmitting a predetermined level of power to a receiver, upon a detection of the receiver; a wireless communication module for receiving, from the receiver, a request for transmitting wireless power; and a Tx Micro Control Unit (MCU) for allocating, upon receiving the request for transmitting the wireless power from the receiver through the wireless communication module, a Short IDentification (SID) and a time slot corresponding to the receiver, transmitting the SID and the time slot to the receiver through the wireless communication module, receiving a request for required power from the receiver through the wireless communication module, determining whether the required power is greater than a residual power of the transmitter, and informing the receiver through the wireless communication module that the required power cannot be transmitted when the required power is greater than the residual power.

### BRIEF DESCRIPTION OF THE DRAWINGS

FIG. 1 is a block diagram illustrating a wireless power transmission/reception system according to an embodiment of the present invention;

FIG. 2 is a block diagram illustrating constructions of a transmitter and a receiver in the wireless power transmission/reception system of FIG. 1 according to an embodiment of the present invention;

FIG. 3 is a flowchart illustrating an example of a method of performing bidirectional communication between the transmitter and the receiver in the wireless power transmission/reception system of FIG. 1 according to an embodiment of the present invention; and

FIG. 4 is a flowchart illustrating another example of a method of performing bidirectional communication between the transmitter and the receiver in the wireless power transmission/reception system of FIG. 1 according to an embodiment of the present invention.

### DETAILED DESCRIPTION OF EMBODIMENTS OF THE PRESENT INVENTION

Hereinafter, embodiments of the present invention will be described with reference to the accompanying drawings. The same or similar components may be designated by the same or similar reference numerals although they are illustrated in the different drawings. Detailed descriptions of constructions or processes known in the art may be omitted to avoid obscuring the subject matter of the present invention. Various specific matters found in the following description, such as specific components, etc., are merely included to help provide a general understanding of the present invention. Accordingly, various changes and modifications can be made thereto without departing from the technical spirit and scope of the present invention.

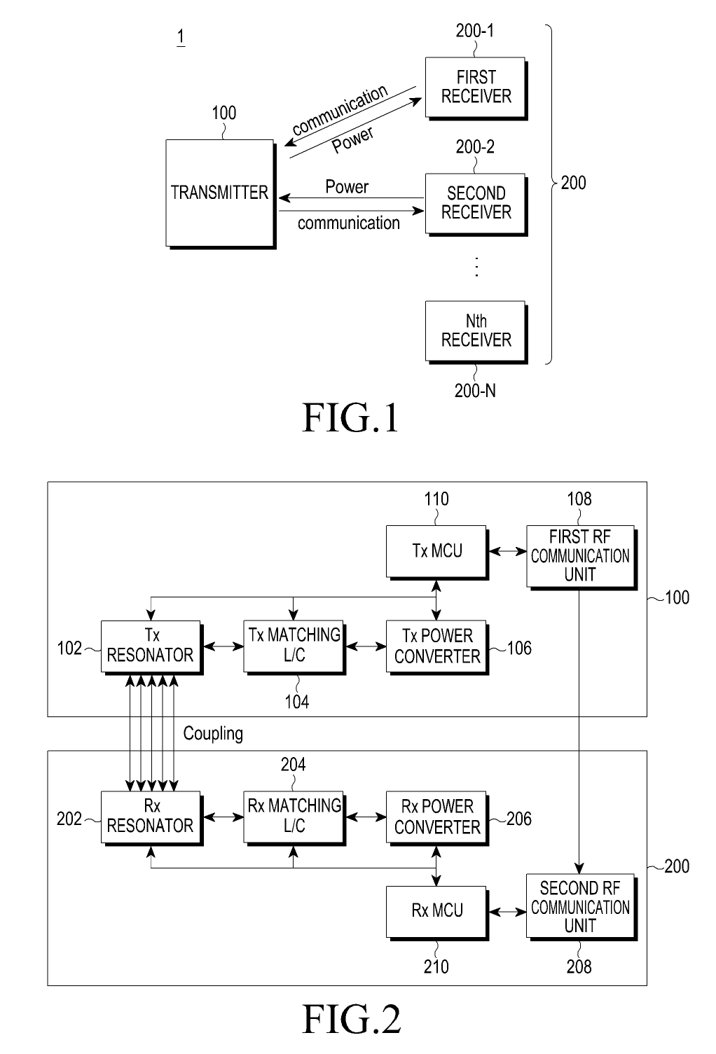

FIG. 1 is a block diagram illustrating a wireless power transmission/reception system according to an embodiment of the present invention.

Referring to FIG. 1, the wireless power transmission/reception system 1 includes a transmitter 100 and receivers 200 including a first receiver 200-1, a second receiver 200-2, . . . , an N^{th} receiver 200-N.

The transmitter 100 transmits wireless power to the receivers 200. The transmitter 100 includes a resonator (hereinafter, referred to as a “transmission (Tx) resonator”), and can transmit the wireless power to the receivers 200 by resonating a carrier frequency including electrical energy by using the Tx resonator.

The transmitter 100 can also perform bidirectional communication with each of the receivers 200 by establishing a communication channel using a frequency different from a frequency used by the resonator. The transmitter 100 can control a transmission cycle of the wireless power transmitted to each of the receivers 200 by performing the bidirectional communication with each of the receivers 200.

The receivers 200 receive the wireless power from the transmitter 100. In order to receive the wireless power from the transmitter 100, the receivers 200 include a resonator (hereinafter, referred to as a “reception (Rx) resonator”). The receivers 200 also include a communication module for performing the bidirectional communication with the transmitter 100.

FIG. 2 is a block diagram illustrating constructions of the transmitter and the receiver in the wireless power transmission/reception system of FIG. 1 according to an embodiment of the present invention.

The transmitter 100 includes the Tx resonator (resonator) 102, a Tx matching circuit (i.e., a matching LC circuit) 104, a Tx power converter 106, a first RF communication unit 108, and a Tx Micro Control Unit (MCU) 110.

The Tx resonator 102 is coupled with the Rx resonator (resonator) 202 of the receiver 200 and resonates an Alternating Current (AC) voltage to a resonance wave in order to supply power to the receiver 200.

The Tx matching circuit 104 includes an impedance that is matched such that a resonance wave resonated by the Tx resonator 102 can be smoothly received through the coupling between the Tx resonator 102 and the Rx resonator 202. The Tx matching circuit 104 controls the impedance under a control of the Tx MCU 110.

The Tx power converter 106 converts a Direct Current (DC) voltage received from a DC adaptor (not shown) connected with the transmitter 100 to an AC voltage. For example, in order to convert the DC voltage, the Tx power converter 106 may include a Class-E amplifier (Class-E Amp) (not shown) corresponding to a power amplifier and a driver amplifier (Driver Amp) (not shown). The driver amplifier converts the DC voltage received from the DC adaptor to the AC voltage. Further, the Class-E amplifier can receive the AC voltage converted through the driver amplifier to amplify the AC voltage under a control of the Tx MCU 110.

For example, the transmitter 100 receives a DC voltage of 7V to 15V from the DC adaptor (not shown). When the DC voltage is input, the Tx MCU 110 controls the Tx power converter 106 to convert the DC voltage to the AC voltage and amplify the converted AC voltage. According to an embodiment of the present invention, the Tx MCU 110 can control an amplification rate of the AC voltage of the Tx power converter 106. The amplified AC voltage is transferred to the Rx resonator 202 of the receiver 200 by the Tx resonator 102.

The first RF communication unit 108 performs wired or wireless communication of the transmitter 100. The first RF communication unit 108 can receive a request for supplying power or a request for stopping supplying power from the receiver 200. The first RF communication unit 108 according to the embodiment of the present invention can perform bidirectional communication with the receiver 200 by establishing a communication channel of a frequency band other than a frequency used by the Tx resonator 102. The first RF communication unit 108 can inform the receiver 200 of a cycle on which power is transmitted from the transmitter 100 or inform the receiver 200 that the power cannot be transmitted, by using the communication channel.

According to an embodiment of the present invention, the first RF communication unit 108 performs bidirectional communication with the receiver 200 through a Radio Frequency IDentification (RFID) communication scheme using a 2.4 GHz frequency band, and accordingly the first RF communication unit 108 may include an RFID reader and/or an RFID tag. When the first RF communication unit 108 includes the RFID reader or the RFID tag according to the RFID communication scheme, a second RF communication unit 208 of the receiver 200 also may include an RFID reader and/or an RFID tag using the 2.4 GHz frequency band.

According to another embodiment of the present invention, the first RF communication unit 108 can perform bidirectional communication with the receiver 200 through a Near Field Communication (NFC) scheme using a 13.56 MHz frequency band, and accordingly, the first RF communication unit 108 may include an NFC communication chip. Further, when the first RF communication unit 108 includes the NFC communication chip, the second RF communication unit 208 can perform bidirectional communication with the first RF communication unit 108 through the NFC communication chip.

The Tx MCU 110 controls a general operation of the transmitter 100. The Tx MCU 110 controls the transmitter 100 to receive the DC voltage from the DC adapter and controls a magnification of the amplified AC voltage by controlling the power converter 106. Further, when charging of the receiver 200 is completed, the Tx MCU 110 controls the transmitter 100 to stop transmitting the power to the receiver 200. Furthermore, according to an embodiment of the present invention, the Tx MCU 110 achieves more smooth power transmission of the transmitter 100 by controlling the impedance of the Tx matching circuit 104. The Tx MCU 110 calculates power efficiency by comparing power transmitted from the transmitter 100 and power transferred to the receiver 200. Based on the calculated power efficiency, the Tx MCU 110 can control the impedance of the Tx matching circuit 104 such that the power efficiency is maximized.

The receiver 200 includes a reception (Rx) resonator (resonator) 202, an Rx matching circuit (matching L/C) 204, an Rx power converter 206, a second communication unit 208, and an Rx Micro Control Unit (MCU) 210.

The Rx resonator 202 receives wireless power from the transmitter 100 by being coupled with the Tx resonator 102 of the transmitter 100 and receiving a resonance wave resonated by the Tx resonator 102.

The Rx matching circuit 204 can control the impedance that is matched such that the resonance wave resonated by the Tx resonator 102 can be smoothly received through the coupling between the Tx resonator 102 and the Rx resonator 202. According to an embodiment of the present invention, a total impedance of the Tx matching circuit 104 and a total impedance of the Rx matching circuit 204 may be matched to have the same value.

The Rx power converter 206 converts the AC voltage received through the Rx resonator 202 to the DC voltage. For example, in order to convert the voltage, the Rx power converter 206 includes an AC/DC rectifier (not shown) and a DC/DC converter (not shown). The AC/DC rectifier converts the AC voltage received through the Rx resonator 202 to the DC voltage. The DC/DC converter amplifies the DC voltage converted through the AC/DC rectifier. The Rx power converter 206 transfers the DC voltage output through the DC/DC converter to a device connected with the receiver 200, for example, a portable terminal (not shown) so that the portable terminal can be driven with the DC voltage.

The second RF communication unit 208 performs wired or wireless communication of the receiver 200. The second RF communication unit 208 sends a request for supplying power or a request for stopping a supply of power to the transmitter 100. The second RF communication unit 208 establishes a communication channel of a frequency band other than a frequency used by the Rx resonator 202 and performs bidirectional communication with the transmitter 100. The second RF communication unit 208 is informed of a transmission cycle of wireless power received from the transmitter 100, or is informed that the transmitter 100 cannot transmit the wireless power.

According to an embodiment of the present invention, the first RF communication unit 108 performs bidirectional communication with the receiver 200 through a Radio Frequency Identification (RFID) communication scheme using a 2.4 GHz frequency band, and accordingly the first RF communication unit 108 includes an RFID reader and/or an RFID tag. When the first RF communication unit 108 includes the RFID reader and/or the RFID tag according to the RFID communication scheme, the second RF communication unit 208 of the receiver 200 also includes the RFID reader and/or the RFID tag using the 2.4 GHz frequency band.

According to an embodiment of the present invention, the second RF communication unit 208 performs bidirectional communication with the transmitter 100 through the RFID communication scheme using the 2.4 GHz frequency band, and accordingly, the second RF communication unit 208 includes an RFID reader and/or an RFID tag. When the second RF communication unit 208 includes the RFID reader and/or the RFID tag according to the RFID communication scheme, the first RF communication unit 108 of the transmitter 100 also includes an RFID reader and/or an RFID tag using the 2.4 GHz frequency band.

According to another embodiment of the present invention, the second RF communication unit 208 can perform bidirectional communication with the transmitter 100 through a Near Field Communication (NFC) scheme using the 13.56 MHz frequency band, and accordingly, the second RF communication unit 208 can use an NFC communication chip. Further, when the second FR communication unit 208 includes the NFC communication chip, the first RF communication unit performing bidirectional communication with the second RF communication unit 208 also uses the NFC communication chip.

The Rx MCU 210 controls a general operation of the receiver 200. The Rx MCU 210 according to the embodiment of the present invention controls the receiver 200 such that a DC voltage for driving a portable terminal connected with the receiver 200 is transferred.

The Rx MCU 210 controls an amplification rate of the amplified DC voltage by controlling the Rx power converter 206. The Rx MCU 210 controls smooth reception of wireless power transferred through the Tx resonator 102 of the transmitter 100 by controlling the impedance of the Rx matching circuit 204.

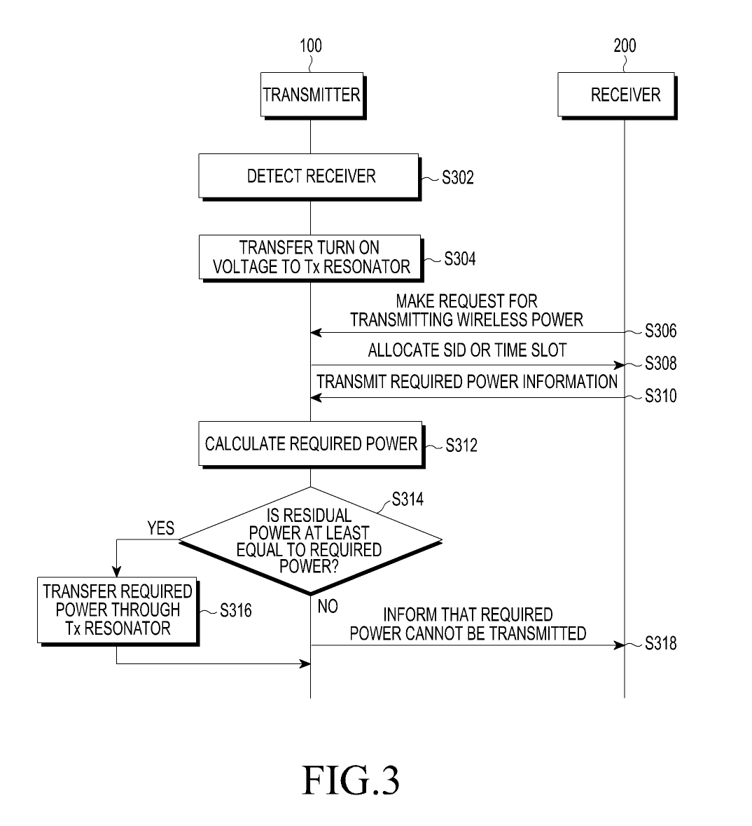

FIG. 3 is a flowchart illustrating an example of a method of performing bidirectional communication between the transmitter and the receiver in the wireless power transmission/reception system of FIG. 1 according to an embodiment of the present invention.

According to an embodiment of the present invention, the transmitter 100 monitors a load fluctuation of a charging pad (not shown) provided in advance. The transmitter 100 can transmit a minimum power (Ps1) with which the receiver 200 can send a response to the Tx resonator 102 during a predetermined short time (Ts) on a predetermined cycle. The transmitter 100 converts Psi to a second power (Ps2), which is wireless power, and resonates converted Ps2 through the Tx resonator 102. As described above, the transmitter 100 outputs an extremely small amount of power via Ps2 (i.e., the minimum power) to an outside on the time cycle of Ts. Further, the transmitter 100 receives the minimum power of Ps2 and monitors whether there the receiver 200 sends a response to Ps2.

Hereinafter, a method of performing bidirectional communication between the transmitter 100 and the receiver 200 is described with reference to FIG. 3. The method starts at a step in which the transmitter 100 detects the receiver 200 having received the converted wireless power Ps2 from the transmitter 100. At this time, the receiver 200 can obtain driving power with which the receiver 200 can send a response to the transmitter 100 by receiving the converted wireless power Ps2. According to an embodiment of the present invention, the Tx MCU 110 of the transmitter 100 transmits the converted wireless power Ps2 only within an area in which the first RF communication unit 108 can perform communication, for example, an area in which RFID communication or NFC communication is possible.

Referring to FIG. 3, when the transmitter 100 detects the receiver 200 in step S302, the transmitter 100 transfers a turn on voltage to the receiver 200 by using the Tx resonator 102, in step S304. According to an embodiment of the present invention, the turn on voltage can be a minimum power for performing various operations of the receiver 200 to be registered in the transmitter 100 to receive wireless power from the transmitter 100.

The receiver 200, upon having received the turn on voltage from the transmitter 100, sends a request for transmitting wireless power to the transmitter 100 through the second communication unit 202, in step S306. The Tx MCU 110 of the transmitter 100 allocates an SID or a time slot to the receiver 200 in step S308, and the allocated SID and time slot are transmitted to the receiver 200 through the first RF communication unit 102.

With respect to the method of FIG. 3, the SID refers to a short ID allocated to the receiver through the transmitter 100. Whenever the transmitter 100 transmits wireless power or transmits data containing various information pieces to the receiver 200, the transmitter 100 includes the SID in the data, so that a destination of corresponding data can be indicated. The time slot refers to a time cycle on which the transmitter 100 performs the bidirectional communication with the receiver 200 or a time cycle on which the transmitter 100 transmits wireless power to the receiver 200.

When the SID or the time slot is allocated, the receiver 200 transmits required power information to the transmitter 100 through the second RF communication unit 208. The transmitter 100 calculates power required by the receiver 200 by using the required power information, in step S312. The transmitter 100 determines whether residual power of the transmitter 100 is at least equal to the required power, in step S314.

The wireless power, which can be transmitted to one or more receivers 200 by the transmitter 100, has a limitation value (i.e., a limitation on the total amount of power that may be transmitted). Accordingly, the transmitter 100 must grasp the residual power and determine whether wireless power for charging the receiver 200 can be transmitted by determining whether the power required by the corresponding receiver 200 is at least equal to the residual power. For example, when the residual power of the transmitter 100 is 50 W and the required power of the receiver 200 is 45 W, the transmitter 100 can transmit wireless power of 45 W to the receiver 200 by performing a charging operation for the receiver 200. When the residual power of the transmitter 100 is 50 W and the required power of the receiver 200 is 55 W, the transmitter 100 cannot perform the charging operation for the receiver 200.

When the residual power is determined to be at least equal to the required power in step S314, the transmitter 100 transfers the required power to the Rx resonator 202 through the Tx resonator 102, in step S316. However, when the residual power is determined to be less than the required power in step S314, the transmitter 100 informs the receiver 200, through the first RF communication unit 102, that the required power cannot be transmitted, in step S318. According to an embodiment of the present invention, bidirectional communication between the transmitter 100 and the receiver 200 can be implemented only during the time slot allocated to the receiver 200 by the transmitter 100.

According to another embodiment of the present invention, the detection of the receiver 200 is performed by communication between the first RF communication unit 108 and the second RF communication unit 208. For example, if the first RF communication unit 108 includes an RFID reader, and the second RF communication unit 208 includes an RFID tag, when the second RF communication unit 208 enters an area within a range for RFID communication with the first RF communication unit 108, the RFID Reader of the first RF communication unit 108 detects the RFID tag of the second RF communication unit 208. Accordingly the first RF communication unit 108 can detect the second RF communication unit 208. When the second RF communication unit 208 is detected, the Tx MCU 110 of the transmitter 100 detects the receiver 200 including the second RF communication unit 208.

According to further another embodiment of the present invention, each of the first RF communication unit 108 and the second RF communication unit 208 includes an NFC communication chip. In this case, if the second RF communication unit 208 enters an area within a range for NFC communication with the first RF communication unit 108, the NFC communication chip of the first RF communication unit 108 detects the NFC communication chip of second RF communication unit 208. Accordingly the first RF communication unit 108 can detect the second RF communication unit 208. When the second RF communication unit 208 is detected, the Tx MCU 110 of the transmitter 100 detects the receiver 200 including the second RF communication unit 208.

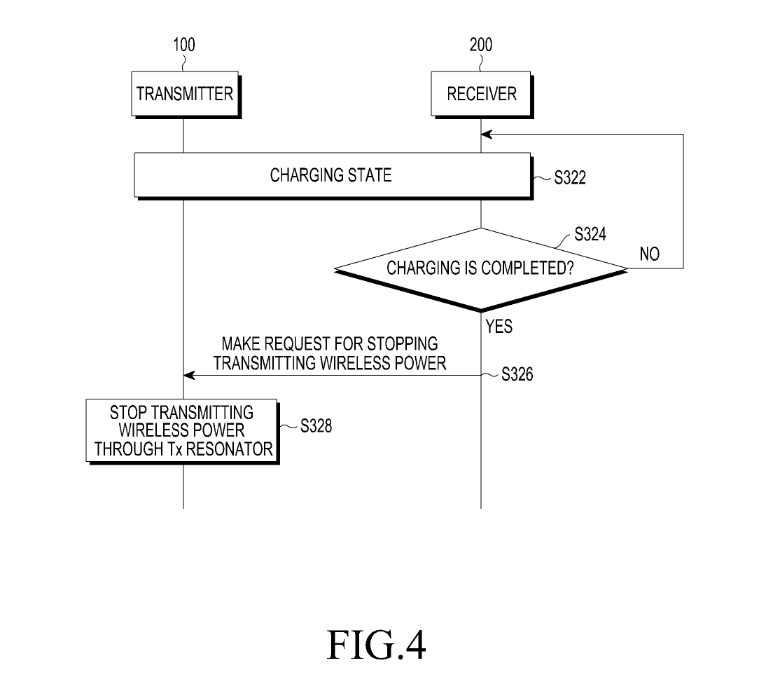

FIG. 4 is a flowchart illustrating another example of a method of performing bidirectional communication between the transmitter and the receiver in the wireless power transmission/reception system of FIG. 1 according to an embodiment of the present invention.

In the example according to FIG. 4, the transmitter 100 is transmitting wireless power to the receiver 200, (i.e., the transmitter 100 and the receiver 200 are in a charging state). The Rx MCU 210 of the receiver 200 determines whether charging is completed in the charging state, in step S324.

Upon a determination that charging is not completed in step S324, the Rx MCU 210 maintains the charging state, in step S322. Upon a determination that charging is completed in step S324, the Rx MCU 210 makes a request to stop transmission of wireless power to the transmitter 100 through the second RF communication unit 208, in step S326.

The transmitter 100 receives a request for stopping transmission of the wireless power from the receiver 200 through the first RF communication unit 108. The Tx MCU 110 of the transmitter 100 stops transmitting the wireless power through the Tx resonator 102, in step S328.

According to an embodiment of the present invention, the Rx MCU 210 of the receiver 200 can also make a request for stopping transmission of wireless power from the transmitter 100 when an over voltage or an over current is generated within the receiver 200.

While the invention has been shown and described with reference to certain embodiments thereof, it will be understood by those skilled in the art that various changes in form and details may be made therein without departing from the spirit and scope of the invention as defined by the appended claims.

As described above, embodiments of the present invention provide the method and the apparatuses for performing bidirectional communication between the transmitter and the receiver in the wireless power transmission/reception system which can efficiently transmit/receive wireless power through the bidirectional communication between the transmitter and the receiver in the wireless power transmission/reception system.

What is claimed is:

1. A method of performing bidirectional communication by a transmitter in a wireless power transmission/reception system, the method comprising:
detecting a receiver;
transmitting, when the receiver is detected, a predetermined level of power to the receiver through a transmission (Tx) resonator;
receiving a request for transmitting wireless power from the receiver through a wireless communication module;
allocating a Short IDentification (SID) and a time slot corresponding to the receiver;
transmitting the SID and the time slot to the receiver through the wireless communication module;
receiving a request for required power from the receiver through the wireless communication module;
determining whether the required power is greater than a residual power of the transmitter; and
when the required power is greater than the residual power, informing the receiver through the wireless communication module that the required power cannot be transmitted.

2. The method as claimed in claim 1, further comprising transmitting the required power to the receiver through the Tx resonator when the residual power at least equal to the required power.

3. The method as claimed in claim 1, wherein detecting the receiver comprises:
checking a load fluctuation of a minimum power output through the Tx resonator in an area where communication is possible through the wireless communication module; and
determining, when there is the load fluctuation of the minimum power, that the receiver is detected.

4. The method as claimed in claim 1, wherein the wireless communication module communicates through a Radio Frequency Identification (RFID) communication scheme.

5. The method as claimed in claim 1, wherein the wireless communication module communicates through a Near Field Communication (NFC) communication scheme.

6. The method as claimed in claim 1, wherein the predetermined level of power is a minimum power level for performing certain operations of the receiver.

7. A transmitter in a wireless power transmission/reception system, the transmitter comprising:
a transmission (Tx) resonator for transmitting a predetermined level of power to a receiver, upon a detection of the receiver;
a wireless communication module for receiving, from the receiver, a request for transmitting wireless power; and
a Tx Micro Control Unit (MCU) for allocating, when receiving the request for transmitting the wireless power from the receiver through the wireless communication module, a Short IDentification (ID) and a time slot corresponding to the receiver, transmitting the SID and the time slot to the receiver through the wireless communication module, receiving a request for required power from the receiver through the wireless communication module, determining whether the required power is greater than a residual power of the transmitter, and informing the receiver through the wireless communication module that the required power cannot be transmitted when the required power is greater than the residual power.

8. The transmitter as claimed in claim 7, wherein the Tx MCU transmits the required power to the receiver through the Tx resonator when the residual power is at least equal to the required power.

9. The transmitter as claimed in claim 7, wherein in the detection of the receiver, the Tx MCU checks a load fluctuation of a minimum power output through the Tx resonator in an area where communication is possible through the wireless communication module, and determines that the receiver is detected when there is the load fluctuation of the minimum power.

10. The transmitter as claimed in claim 7, wherein the wireless communication module communicates through a Radio Frequency Identification (RFID) communication scheme.

11. The transmitter as claimed in claim 7, wherein the wireless communication module communicates through a Near Field Communication (NFC) communication scheme.

12. The transmitter as claimed in claim 7, wherein the predetermined level of power is a minimum power level for performing certain operations of the receiver.
